(19) United States
(12) Patent Application Publication
(10) Pub. No.: US 2026/0086769 A1
(43) Pub. Date: Mar. 26, 2026

(54) APPARATUS AND METHOD FOR EFFICIENT MULTI-DIMENSIONAL DATA PROCESSING

(71) Applicant: Intel Corporation, Santa Clara, CA (US)

(72) Inventors: Deepali Garg, Indore (IN); Baishik Biswas, Bangalore (IN); Prashant Laddha, Bengaluru (IN); Om Ji Omer, Bangalore (IN); Sreenivas Subramoney, Bangalore (IN)

(73) Assignee: Intel Corporation, Santa Clara, CA (US)

(21) Appl. No.: 19/406,823

(22) Filed: Dec. 2, 2025

(51) Int. Cl. G06F 7/523; G06F 7/50

(52) U.S. Cl. CPC G06F 7/523; G06F 7/50

(57) ABSTRACT

Techniques for efficient multi-dimensional data processing. For example, front end circuitry sorts tuples across a plurality of tuple buffers to provide conflict-free access to a corresponding plurality of input data banks without memory access conflicts, each tuple to associate an input data element of a plurality of input data elements with a corresponding weight data element of a weight tensor and a corresponding output data element of an output tensor; and execution circuitry to perform multiply-accumulate operations using a subset of the tuples, the execution circuitry to perform parallel multiplications with a corresponding subset of input data elements of the plurality of input data elements and a corresponding subset of weight data elements of the weight tensor indicated by the subset of the tuples, the execution circuitry to access the subset of input data elements from different input data banks of the plurality of input data banks without memory conflicts.

### BACKGROUND

### Field of the Invention

This invention relates generally to the field of processors. More particularly, the invention relates to an apparatus and method for efficient multi-dimensional spatially sparse data processing.

### Description of the Related Art

Applications in robotics, augmented reality (AR), virtual reality (VR), extended reality (XR), autonomous driving, and navigation operate using an understanding of 3D geometry and graphics semantics. Point clouds offer a natural and expressive way to represent 3D geometry, and deep neural networks—such as convolutional neural networks (CNNs) and graph neural networks (GNNs)—operating on these point clouds have become the standard for scene analytics and semantic understanding. However, point cloud neural networks (e.g., deep neural networks) present highly irregular, input-dependent memory and compute behaviors due to the spatial sparsity of 3D scenes. This creates unique challenges for conventional CNN accelerators such as graphics processors (GPUs), neural processing units (NPUs), tensor processing units (TPUs), and instructions which are optimized for dense, regularly structured grid data (e.g., tile multiplication (TMUL) instructions and advanced matrix extensions (AMX) instructions).

### BRIEF DESCRIPTION OF THE DRAWINGS

A better understanding of the present invention can be obtained from the following detailed description in conjunction with the following drawings, in which:

FIG. 1A illustrates an example for performing a spatially sparse convolution using metadata.

FIG. 1B illustrates an example in which input data and weights can result in memory bank conflicts.

FIG. 2 illustrates an implementation for generating and processing conflict free multiply-accumulate groups.

FIG. 3 illustrates an example accelerator compute cluster comprising a plurality of compute cores.

FIG. 4 illustrates an example bank-aware tuple storage unit storing a plurality of weight plane groups.

FIG. 5 illustrates an example arrangement of cache banks and a weight value prefetcher in relation to conflict-free MAC groups.

FIG. 6 illustrates an example with weight plane group storage and tuple schedulers.

FIG. 7 illustrates an embodiment with an input data fetcher and a weight plane prefetcher.

FIG. 8 illustrates the impact of using weight plane groups of different sizes on utilization.

FIG. 9 illustrates the impact of using weight plane groups of different sizes on tuple storage size.

FIG. 10 illustrates compute utilization based on workload sparsity with and without tuple lookahead.

FIG. 11 illustrates a method in accordance with some implementations of this disclosure.

FIG. 12 illustrates decoder circuitry and logic in accordance with some implementations of this disclosure.

FIG. 13 illustrates the decoder circuitry and logic in combination with a plurality of example weight groups.

FIG. 14 is a block diagram of a processing system, according to an embodiment.

### DETAILED DESCRIPTION

Embodiments of this disclosure include a data-access-aware spatially sparse accelerator configured to avoid memory bank conflicts originating from the inherently irregular data patterns in spatially sparse workloads. In particular, a combination of banking-aware tuple scheduling and weight-group stationary dataflow is used to avoid memory bank conflicts, maximize data reuse, and balance workload skew. These implementations ensure improved compute utilization and more efficient memory access, even for workloads which exhibit significant irregularity.

In particular, banked tuple storage and weight grouping may be used to alleviate bank conflicts. Metadata is generated which maps each input data element (I) of an input feature map (IFM) to a weight value (W) of a weight matrix and an output data element (O) of an output feature map (OFM). Each I-W-O tuple of the metadata is evaluated to determine the most efficient order in which to execute the corresponding multiply-accumulate (MAC) operations on a plurality of MAC units.

Scheduling may also be performed in accordance with a weight stationary execution model, i.e., improving efficiency by minimizing data movement, specifically for the weight matrix. The weights are “stationary,” meaning that they are pre-loaded into the local memory or registers of the individual processing elements (PEs) and reused for multiple successive MAC operations.

By way of example, and not limitation, for a particular IFM identified by a unique identifier, x, the active weight plane (Wₚ) may be defined by: Wₚ=3×floor((x mod 8)/N) and each weight group (W_{g}) may be defined by W_{g}(x)=floor((x mod 8), where N is a tunable parameter between 1 and 8, and the output feature map (OFM) directly corresponds to the IFM.

Thus, for N=1, all IFMs of the form 8k+j map to Wg=j, leading to all entries in each weight group corresponding to the same IFM bank j. Similarly, N=8 results in all 8 consecutive IFMs mapping to a single weight group, allowing entries in each weight group to be uniformly distributed across IFM banks, leading to high utilization (e.g., 100% in some implementations).

Given the highly sparse nature of point clouds (e.g., with active points in less than 0.1% of the total space), point clouds are represented using sparse data structures rather than regular 3D grids. In general, sparse data structures use some form of indexing to track the locations of non-zero values in a sparse data set. For example, a sparse matrix may be encoded as a block of adjacent data elements with indices indicating data element locations within the sparse matrix matrix.

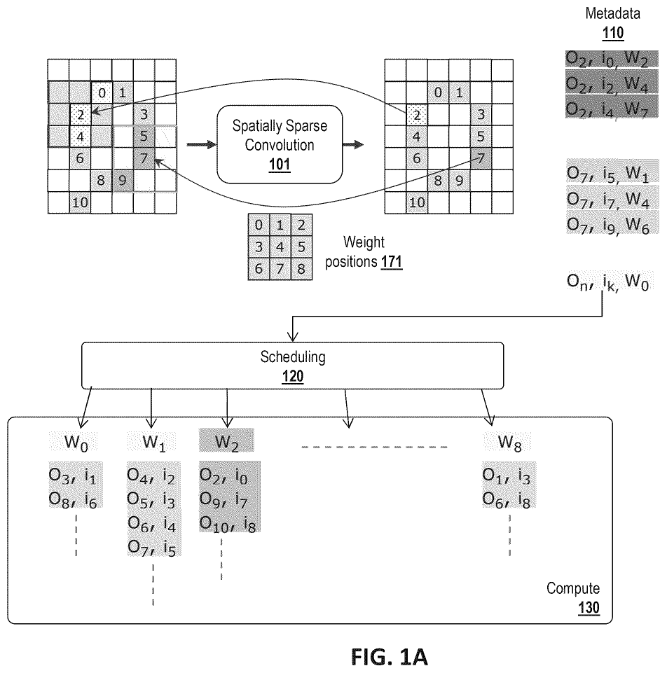

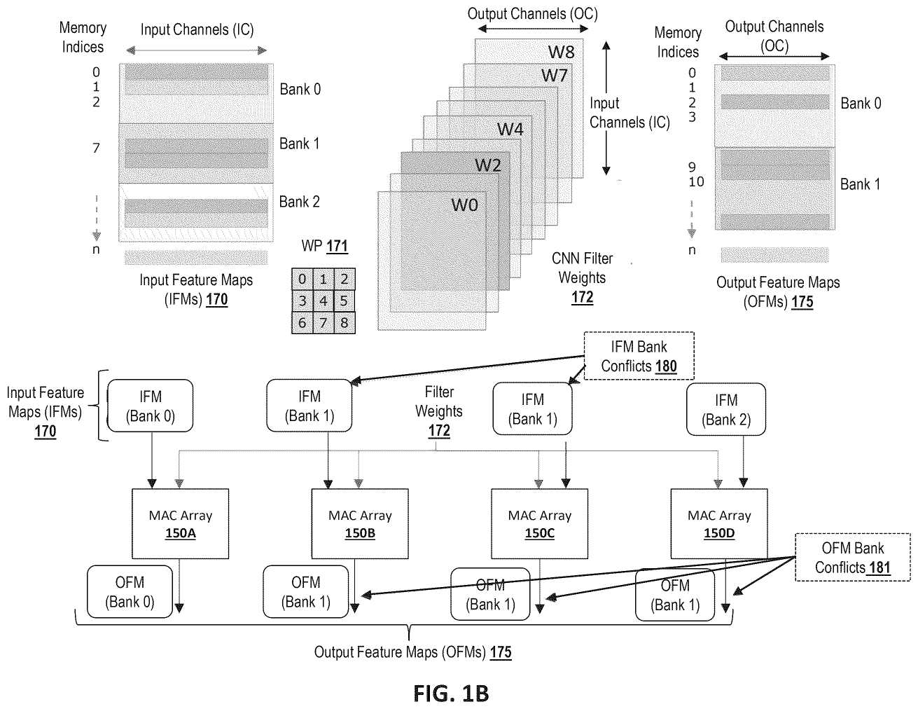

FIG. 1A illustrates an example of a spatially sparse convolution operation 101 with matrix locations of sparse input data elements (I), output data elements (O), and weights (W) encoded in metadata 110. During execution, scheduling logic 120 parses the metadata 110 and schedules a series of parallel V×M (vector*matrix) or M×M (matrix*matrix) operations on a compute circuit 130, which may include one or more multiply-accumulate (MAC) units for multiplying the input feature data elements with corresponding weight values of the weight matrix. For example, each operation may multiply a data element of an input feature vector or matrix and a corresponding data element of a weight matrix (located as indicated by a corresponding weight matrix position value 171). In the illustrated example, the metadata 110 may comprise a plurality of tuples, each tuple indicating an input data element from the input feature vector or matrix (Iₓ), a corresponding weight data element of the weight matrix (Wₓ), and a corresponding output data element (Oₓ).

FIG. 1B illustrates an example of the sparse input data elements arranged in input feature maps (IFMs) 170, filter weights 172 of a weight matrix (e.g., and associated weight positions 171), and output data elements arranged in output feature maps (OFMs) 175. For a high performance implementation, multiple operations (e.g., uops) are scheduled to execute in parallel on a plurality of multiply-accumulate (MAC) array partitions 150A-D, requiring simultaneous fetching of input and output operands from arbitrary, non-contiguous memory locations. In operation, each input data element in an IFM 170 is multiplied by a corresponding filter weight 172 to generate a product, which may be added to other products and/or accumulated with an accumulation value to generate a corresponding output feature map data element in an OFM 175. Respective portions of the IFMs 170 and CNN filter weights 172 are input to different MAC array partitions 150A-D, which operate in parallel to generate corresponding output data elements in the output feature map 175.

These irregular access patterns can lead to bottlenecks such as excessive memory accesses and inefficient reuse of operand data in local/on-chip memory (e.g., cache/SRAM) resulting from the lack of spatial and temporal locality across uops and frequent bank conflicts in local memory, including IFM bank conflicts 180 and OFM bank conflicts 181, as multiple disconnected operands are fetched and processed in parallel.

As mentioned, a data access-aware spatially sparse accelerator may be implemented which reduces memory bank conflicts originating from the irregular data patterns in spatially sparse workloads. In particular, banking-aware tuple scheduling and weight-group stationary dataflow operations are performed in tandem to provide conflict-free access to source operands, avoid memory bank conflicts, maximize data reuse, and balance workload skew. As used herein, “conflict-free access” to a source operand means that access to the source operand is not delayed as a result of one or more other concurrent memory accesses (e.g., accesses to the same memory bank or accesses which consume the available resources of the memory subsystem). These implementations enable high compute utilization and efficient memory access, even for workloads which exhibit significant irregularity.

In some implementations, banking-aware front end circuitry dynamically detects and resolves unpredictable bank conflicts in real time. In contrast to static banking schemes, the front end circuitry actively manages both data placement and operation scheduling (e.g., uop scheduling) at the memory bank level, dynamically adapting to workload irregularities to maintain improved throughput and compute utilization, even in the face of unpredictable access patterns.

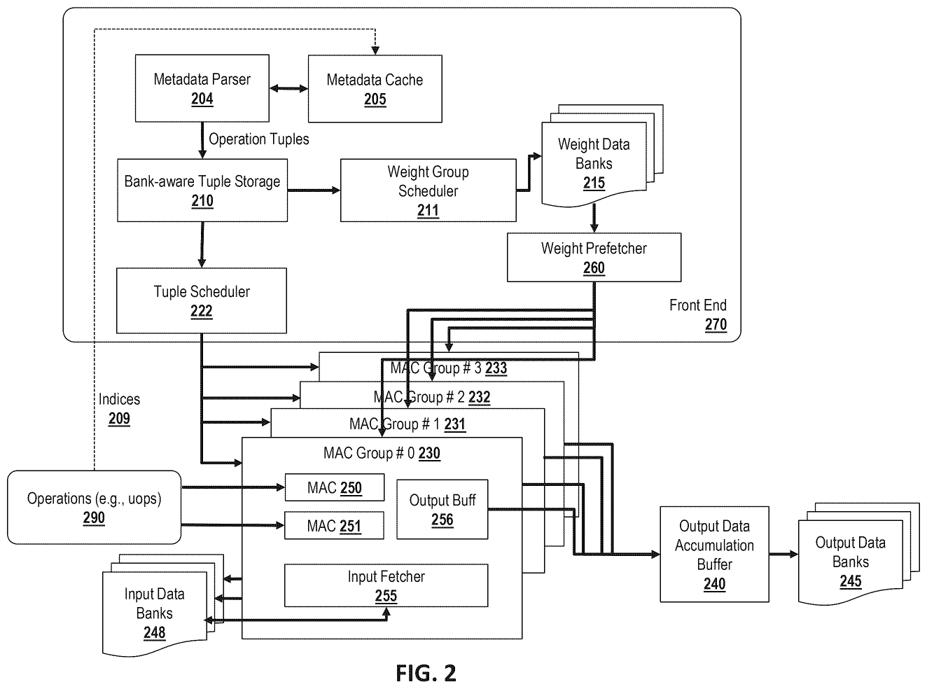

FIG. 2 illustrates front end circuitry 270 which performs data fetching and conflict-free scheduling of operations on multiply-accumulate circuitry 230-233 in accordance with the embodiments of this disclosure. A metadata cache 205 stores metadata corresponding to each input data element (I), output data element (O), and weight data element (W). The metadata may include indices 209 associated with operations 290 to be performed by the MAC units 250-251 of each MAC group 230-233. As used herein, “indices” refers to any information for determining the location of the input data elements, output data elements, and weight data elements within the respective input, output, and weight matrices. In some implementations, the operations 290 comprise microoperations (uops) generated by a decoder upon decoding a corresponding command or instruction (used interchangeably herein). In the illustrated implementation, the input data elements corresponding to the operations 290 are stored in a set of input data banks 248, the output data elements are stored in output data banks 245, and the filter weight data elements are stored in weight data banks 215.

A metadata parser 204 evaluates the metadata to generate operation tuples (e.g., uop tuples) in bank-aware tuple storage 210. Operations (e.g., uops of decoded commands) are pre-sorted into bank-indexed buffers in bank-aware tuple storage 210 based on an index-based memory banking policy configured to provide conflict-free memory access. A tuple scheduler 222 reads the tuples from the bank-aware tuple storage 210 using a lookahead mechanism, as described below.

In some embodiments, the input data banks 248, which store the input data elements, are grouped into pairs. For example, eight input data banks may be grouped into four pairs of data banks and four tuples are evaluated from each pair. Based on the evaluation, two of the four tuples with non-overlapping input and output bank indices are dispatched for conflict-free execution on one of a plurality of MAC groups 230-233. For example, when scheduled on MAC group 230, one tuple may be executed by MAC unit 250 while the other tuple is executed by MAC unit 251. Each MAC unit includes circuitry for performing tensor/matrix multiply-accumulate (MAC) operations using input data elements and weight data elements (e.g., to perform a convolution or matrix multiplication). In response to a scheduled tuple, MAC unit 250 may multiply an input data element from the input data banks 248 and a corresponding weight value from the weight data banks 215 to generate a product, which is added to one or more other products and/or accumulated with a prior value in an output data accumulation buffer 240 to generate an output data element which is stored in the output data banks 245.

Using MAC group 230 as a representative example, each MAC group includes an input fetcher 255 to fetch input data elements from input data banks 248 to be multiplied by corresponding weight data elements prefetched by weight prefetcher 260 in the front end circuitry 270. Intermediate results generated by the MAC units 250-251 may be temporarily stored in an output buffer 256 prior to being written to the output data accumulation buffer 240 and/or output data banks 245. Thus, in the illustrated embodiment, each MAC group 230-233 can process two tuples per cycle, with each tuple sourced from consecutive input data banks 248 and mapped to distinct output data banks 245, streamlining scheduling and data routing.

In some embodiments, a weight-grouping stationary dataflow is implemented, where multiple weight planes are clustered into configurable weight plane groups and held stationary near the MAC units 250-251 (e.g., where each weight plane group includes a set of weight planes). Each “weight plane” may be a 2D array of weight values that the accelerator uses to perform multiply-accumulate (MAC) operations in combination with corresponding 2D patches of the input feature values (or “input plane”). The weight plane is sometimes referred to as a 2D convolutional kernel or filter.

Conflict-free tuples are scheduled by tuple scheduler 222 for each weight plane group, and the weight planes in the group are dynamically mapped to the MAC units 250-251 every compute cycle. This configurable mapping allows the workload distribution to be adaptively balanced to maintain efficient compute utilization, while preserving weight data reuse as sparsity patterns change (e.g., reusing weight data stored in the weight data banks 215 for multiple operations performed by the MAC units 250-251).

In these implementations, the weight plane group scheduler 211 dynamically selects a weight plane group in accordance with a defined policy and drains all tuples from bank-aware tuple storage 210 with the goal of avoiding conflicts. By way of example, and not limitation, the defined policy may indicate scheduling from the weight plane group with the highest occupancy. Each weight plane group may be stationary for multiple tuple dispatches. When a weight plane group is selected, its weight planes are prefetched by weight plane group prefetcher 260 and loaded into local weight storage buffers (e.g., in local memory or registers) of the MAC units 250-251. The weight storage buffers may be shared among all MAC units across all conflict-free MAC groups 230-233 and the weight values may be dynamically routed through a multiplexer fabric controlled by the tuple scheduler 222. For example, a MAC unit 250 may multiply each weight value with a corresponding input data element stored in input data banks 248. In these embodiments, the tuple scheduler 222 controls the multiplexer fabric to route each weight value to a multiplier of a MAC unit 250-251 which performs the multiplication with the associated input value.

These implementations provide for a scalable, high-efficiency, high-performance implementation for tensor workloads characterized by sparsity and irregularity (e.g., such as AI and visual analytics workloads). The conflict-aware scheduling architecture efficiently addresses irregular and sparse data access patterns in these workloads with a scalable, hierarchical scheduling framework which optimizes on-chip data movement for N-dimensional sparse data processing, consistently achieving high compute utilization rates (e.g., above 90%).

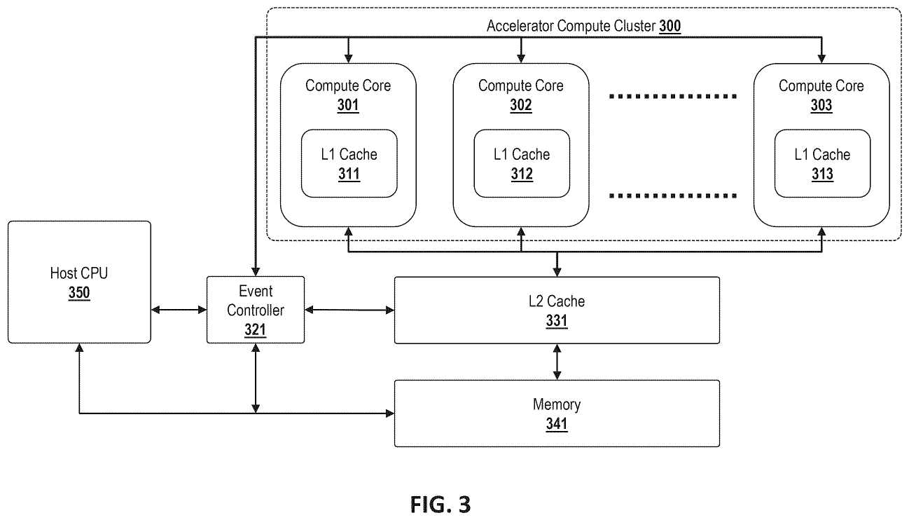

FIG. 3 illustrates an example of an architecture on which embodiments described herein may be implemented. A host CPU 350 and an accelerator compute cluster 300 are coupled to a memory 341 (e.g., DRAM). The accelerator compute cluster 300 comprises a plurality of compute cores 301-303, each with a corresponding L1 cache 311-313, respectively, and coupled to a shared L2 cache 331. An event controller 321 manages platform events (e.g., interrupts, exceptions, completion indications, etc), storing and forwarding event notifications to and from the host CPU 350 and/or the compute cores 301-303. In some implementations, the accelerator compute cluster 300 may be integrated on the same die or chip as the host CPU 350. Alternatively, the accelerator computer cluster 300 may be integrated on a separate die but in the same processor package as the host CPU 350, or may be on an external processor package and coupled to the host CPU 350 via a high-speed interconnect (e.g., PCIe, NVLink).

In accordance with these embodiments, a spatially sparse convolution workload is decoded and translated into a sequence of micro-operations (e.g., a number of multiply-accumulate operations per layer), each defined by input, output, and weight index tuples stored in the bank-aware tuple storage. For sparse layers, the set of active weights and their corresponding output indices per input vector may be generated dynamically by the host CPU 350 and provided to the accelerator compute cluster 300. In some embodiments, the mapping is provided in a compressed format which encodes the correspondence between active weights and the corresponding input/output indices to minimize the footprint in memory 341.

Given that these workloads are memory-bound, tiling algorithms are optimized to partition the large metadata and corresponding data into tiles, maximizing data reuse for each fetch to memory 341 or the L2 cache 331. At execution, a tile of metadata, and the associated input data values, weight data values, and output data values, are loaded into the L1 caches 311-313 of the compute cores 301-303. In operations, a compute core 301 parses the metadata into micro-op tuples, which are scheduled in a weight-stationary fashion as described herein to maximize energy efficiency. One bottleneck which remains unaddressed in existing systems is the irregular and dynamic data access patterns from the L1 caches 311-313 to the corresponding compute units 301-303. These patterns, inherent to spatial sparsity, lead to unpredictable cache bank conflicts and underutilization of compute resources, especially in bandwidth-constrained architectures.

A naïve approach—single micro-op dispatch, fetch, and compute—results in the compute cores 301-303 becoming the bottleneck, which is contrary to the expectation from accelerators designed for memory-bound workloads. This suggests that a single dispatch approach cannot fully exploit the data level parallelism available within the workload's tiles. To maximize operational throughput (e.g., operations/cycle), a wide dispatch-fetch-compute unit is desirable. However, wide fetches are infeasible with conventional architectures due to the dynamic and irregular nature of sparse data accesses, which can cause simultaneous input feature map (IFM) and output feature map (OFM) accesses to collide in cache banks. These conflicts are difficult to resolve in real time, as scheduling k tuples from a large pool while avoiding both IFM and OFM bank conflicts involves a combinatorial search space (proportional to #IFM_Banks×#OFM_Banks), and must be performed within a single cycle to sustain throughput.

Some implementations of this disclosure address these bottlenecks by accelerating spatially sparse convolutions using a wide out-of-order uop dispatch mechanism. A hierarchical scheduling framework is employed that systematically resolves cache bank conflicts and maximizes compute utilization.

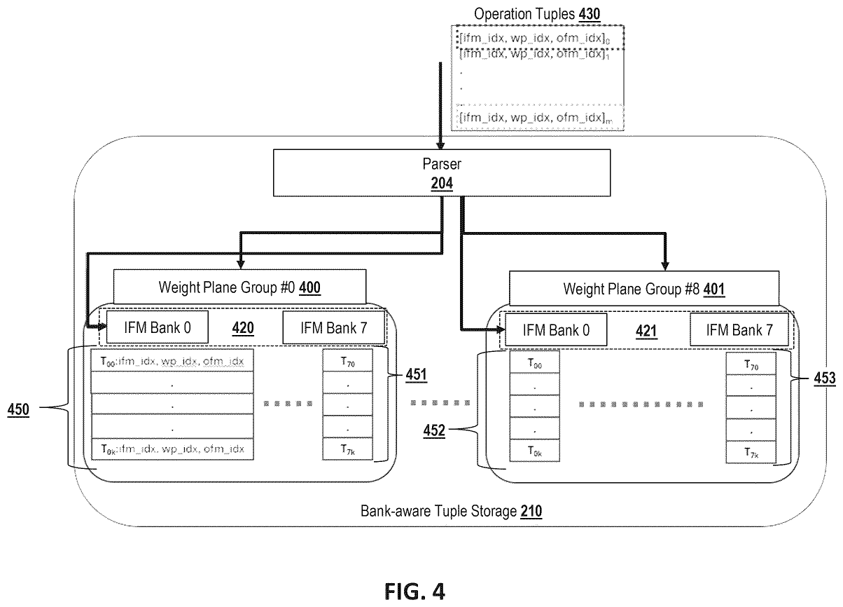

Referring to FIG. 4, operation tuples 430 are parsed by parser 204 which groups the operation tuples in weight plane groups 400-401 according to their associated weights. As previously described, each operation tuple may include index values of input data elements of the input feature map (IFM), the corresponding weight data elements from a weight matrix, and the output data element of an output feature map (OFM) (e.g., indicating a register or memory location for storing the output data elements). Within a weight plane group 400-401, operation tuples 430 are sorted into input feature map (IFM) bank-specific FIFOs 450-453 (only four of which are shown for simplicity), to ensure conflict-free IFM reads. In the illustrated example, weight plane group 400 includes a first set of IFM banks 420 and weight plane group 401 includes a second set of IFM banks 421 and each IFM bank includes a set of bank-specific FIFOs. A one-tuple lookahead per FIFO enables the selection of tuples that are free from both IFM and OFM conflicts, thereby maximizing resource utilization and eliminating computational stalls.

In these implementations, IFM bank conflicts are proactively minimized through decoding and sorting of tuples based on their IFM bank index at the time of storage in the bank-aware tuple storage 210. Each tuple may be stored in a dedicated bank-specific FIFO corresponding to its IFM bank (e.g., IFM bank 0 of weight plane group 400). An index-modulo-based policy guarantees that tuples drawn from the head of each FIFO are always IFM bank conflict-free, enabling seamless scheduling under a weight-stationary execution model, as described further below.

Balanced utilization across weight planes can be achieved by grouping weights into configurable weight plane groups 400-401 in the bank-aware tuple storage units 210. The corresponding weights are copied into the weight data banks 215 by the weight plane group scheduler 211 and fetched for execution by the weight plane group prefetcher 260. Each weight plane group 400-401 shares a set of banking-aware tuple storage units, which broadens the search space for conflict-free tuple selection within the group. This approach is highly scalable and adaptable to various convolution types. For example, a 3×3×3 convolution (27 weight planes) can be divided into 9 groups of 3 planes each, while larger convolutions (e.g., 128 planes) can be supported by adjusting the group size (e.g., increasing the group size via software or firmware). This flexibility allows the architecture to minimize workload skew and maximize data reuse based on specific workload characteristics.

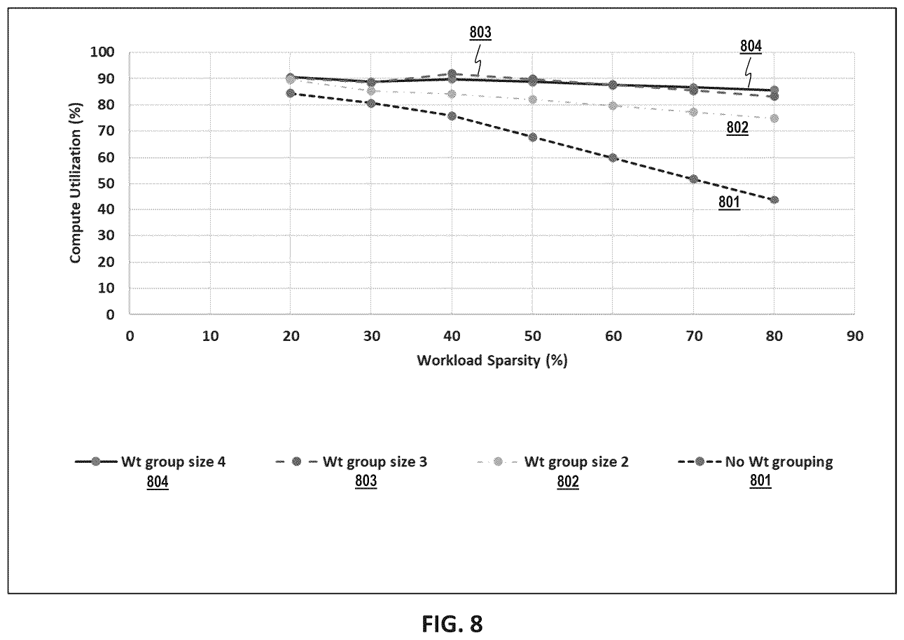

FIG. 8 illustrates plots of compute utilization based on workload sparsity when no weight plane grouping is performed, and when weight plane grouping is performed with weight plane group sizes of 2, 3, and 4.

The data shows that scheduling each weight plane independently can lead to significant skew in IFM bank indices, causing a rapid decline in compute utilization for sparse workloads as indicated by curve 801. By grouping even two weight planes together, this skew is substantially reduced, resulting in a marked improvement in utilization, as indicated by curve 802. Increasing the group size to three planes per group further levels out utilization, though additional gains plateau beyond this point as indicated by curves 803 (weight plane group size of 3) and 804 (weight plane group size of 4). Weight plane grouping thus effectively balances compute utilization across varying sparsity levels and mitigates the impact of uneven workload distribution.

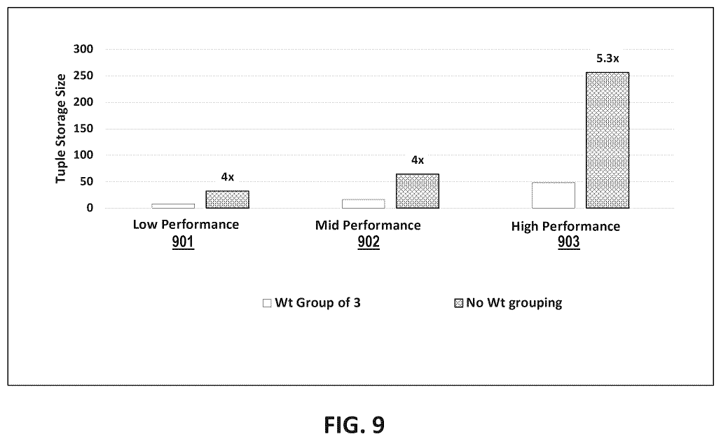

Additionally, without weight plane grouping, the tuple storage required for conflict-free scheduling per weight plane increases substantially. FIG. 9 contrasts tuple storage size with no weight plane grouping and with a weight plane group size of 3 for low performance workload 901, a mid-performance workload 902, and a high performance workload 903. This data illustrates that the storage demand grows markedly without weight plane grouping as performance requirements shift from low performance 901 to mid performance 902 to high performance 903 settings.

Some implementations of the compute microarchitecture employ a group-wise sequential scheduling strategy, processing the weight values of one weight plane group at a time. All uop tuples associated with a selected weight plane group are fully executed before moving to the next group, ensuring that weights remain stationary across multiple compute cycles and enhancing data reuse and energy efficiency.

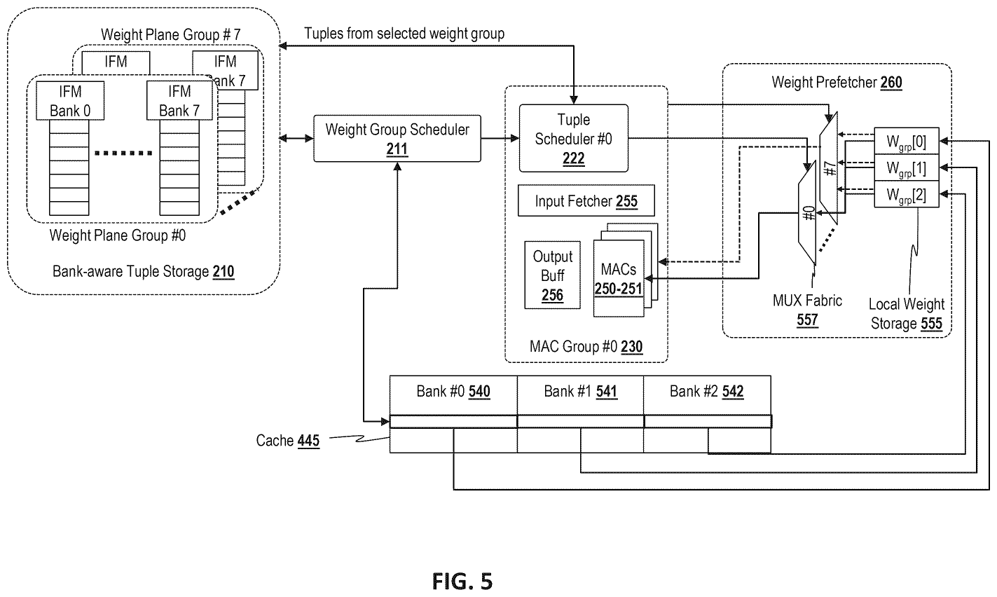

Referring to FIG. 5, in some implementations, the weight plane group scheduler 211 determines which of weight plane groups (#0 to #7) to process next and may select the next weight plane group based, for example, on one or more of: group occupancy (i.e., the number of weight planes in the group), detected access patterns, adaptive heuristics configured for optimal reuse, and/or an ascending order policy in which the next sequential weight plane group is selected.

Once a weight plane group is selected, the corresponding weight values in its weight planes are distributed across different weight cache banks 540-542 of the local cache 445 (e.g., represented in FIG. 2 by weight data banks 215) to guarantee single-cycle access. The weight prefetcher 260 prefetches the weight values from the cache 445 into local weight storage 555 (e.g., local memory buffers or registers) shared among the MAC units across all conflict-free MAC groups (with only MAC units 250-251 of MAC group #0 being shown for simplicity). The weight values stored in the weight storage 555 are dynamically routed via a multiplexer fabric 557 controlled by the tuple scheduler 222 of the associated MAC group (tuple scheduler #0 associated with MAC group #0 in the illustrated example). This dynamic selection and routing ensures that each MAC unit 250-251 receives the required weight values at the precise moment needed (e.g., to multiply the weight values with corresponding input values), maintaining the weight-stationary dataflow and supporting high throughput.

The embodiments described herein can schedule tuples that are free from both IFM and OFM conflicts. Since tuple storage within each weight plane group is pre-sorted by the IFM bank index, reading from the FIFO heads guarantees IFM conflict-free tuples. However, OFM conflicts can still occur and, if left unresolved, can account for up to 30% of conflicts. While OFM accumulation buffers 240 can temporarily absorb write conflicts, excessive conflict rates can quickly fill these buffers, causing frequent compute stalls and degraded performance.

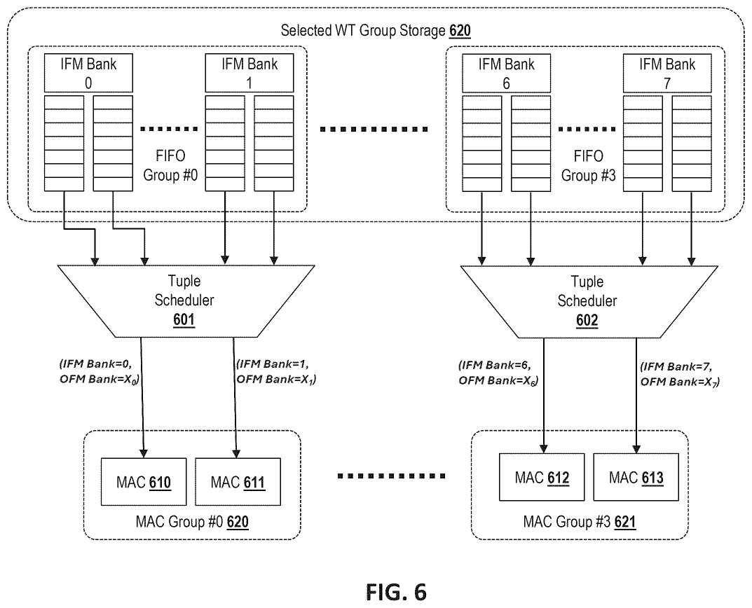

To address this limitation, some embodiments of this disclosure schedule only those tuples that are conflict-free on both the IFM and OFM sides. A brute-force approach which scans all 16 lookahead tuples (one from each IFM bank FIFO) per weight plane group to find 8 conflict-free tuples is computationally infeasible. Instead, some implementations use a one-tuple lookahead mechanism, an example of which is illustrated in FIG. 6. Here, the eight IFM banks are logically grouped into four pairs (FIFO groups #0-3), and only four tuples are examined per group (two from each bank in a group).

FIG. 6 illustrates a first pair, FIFO group #0, comprising IFM banks 0 and 1 and a second pair, FIFO group #3, comprising IFM banks 6 and 7. From each pair, two tuples with non-overlapping OFM and IFM bank indices are selected and dispatched. For example, tuple scheduler 601 selects two tuples with non-overlapping OFM and IFM bank indices from IFM banks 0 and 1 and routes the two tuples to the two corresponding MAC units 610-611 of MAC group 620. Similarly, tuple scheduler 602 selects two tuples with non-overlapping OFM and IFM bank indices from IFM banks 6 and 7 and routes the two tuples to corresponding MAC units 612-613 of conflict-free MAC group 621. The MAC units 610-613 can then perform a conflict-free multiply-accumulate MAC operation on the input data and store the results in the output data buffers or registers (e.g., output data banks 245). This structured scheduling approach ensures high compute utilization, minimal stalls, and scalability—even under highly sparse and irregular data access patterns.

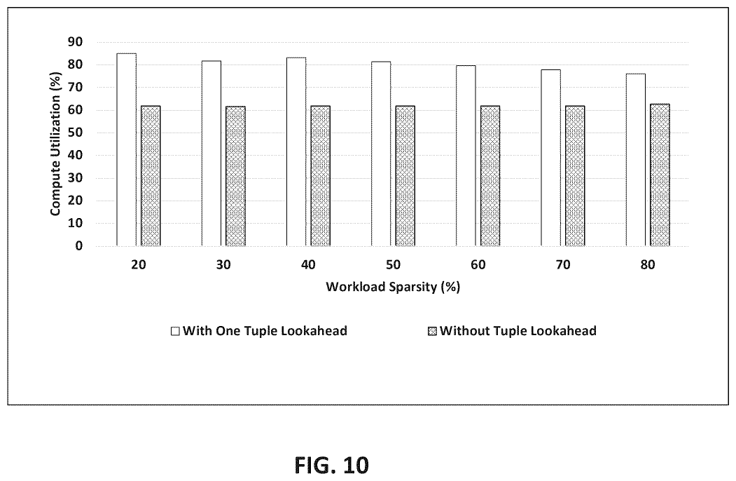

FIG. 10 illustrates results for a particular implementation for workloads with different sparsity levels (20% to 80%), highlighting the increase in compute utilization associated with a one-tuple lookahead (white bars) compared with no lookahead (shaded bars). Thus, the one-tuple lookahead mechanism significantly improves both compute and OFM port utilization.

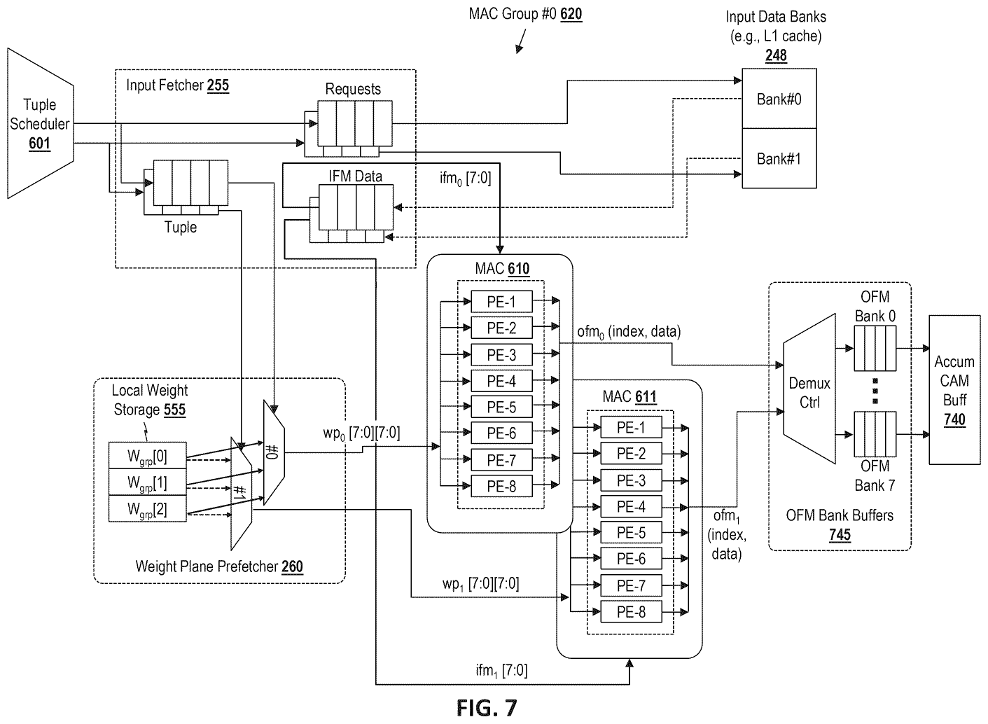

FIG. 7 illustrates additional detail for conflict-free MAC group 620, in accordance with some implementations, including the tuple scheduler 601 which provides two tuples with non-overlapping OFM and IFM bank indices to input fetcher 255. In response, the input fetcher 255 loads the corresponding input data elements from the corresponding input data banks 248 and selectively routes the input data elements to the MAC units 610-611 (e.g., to local buffers or registers coupled to the MAC units). The weight plane prefetcher 260, as previously described, loads the corresponding weight values into local weight storage 555 (e.g., registers or buffer locations) and selectively routes the weight values to each of the MAC units 610-611, which perform multiply-accumulate operations (e.g., as indicated by the commands/uops) to generate output data elements in corresponding OFM bank buffers 745.

Thus, the illustrated conflict-free MAC group 620 processes two tuples per cycle, each guaranteed to originate from consecutive input data banks 248 and mapped to non-overlapping output bank buffers 745, which simplifies both scheduling and data routing. In some implementations, the mapping is hardwired: tuples from even input data banks 248 (e.g., Bank #0) are assigned to MAC unit 610, and those from odd input data banks (e.g., Bank #1) are assigned to MAC unit 611. Each tuple is parsed by the input fetcher 255 to extract the IFM (input data elements), OFM (output data elements), and weight indices. The IFM bank ID and index are used to compute the address in the input data banks 248 (i.e., an IFM L1 cache), which stores input data for fetching. As a result of conflict-free scheduling, these accesses are bubble-free, ensuring deterministic data delivery. Each fetched input data element is routed to the corresponding MAC unit 610-611, and the weight plane index configures the multiplexer fabric in the weight plane prefetcher 260 to deliver the correct weight.

Each MAC unit 610-611 includes multiply-accumulate circuitry to perform a certain number of MAC operations per cycle, generating partial OFM outputs that are routed into per-bank output data accumulation buffers 240. Due to conflict-free scheduling, there is no contention at this stage. To support eight IFM banks (e.g., IFM banks 0-7 in FIG. 6), the system employs four conflict-free MAC groups (e.g., MAC groups #0-3), each with two MAC units, all operating in parallel on disjoint IFM banks, ensuring high throughput and stall-free execution.

While conflict-free scheduling eliminates output feature map (OFM) conflicts within a single conflict-free MAC group, conflicts can still arise across multiple groups when they attempt to write to the same locations within the OFM bank buffers 745. These conflicts can occur when the per-group OFM buffers 745 from each of the four conflict-free MAC groups simultaneously access the shared output data accumulation buffer 740, implemented as a content addressable memory (CAM). To manage this contention, a conflict resolution buffer may be configured that arbitrates write access via a 4:1 priority encoder for each OFM bank. Arbitration may be performed in a round-robin manner to ensure fairness.

To further enhance responsiveness under high pressure, prioritization may be used. For example, any conflict-free MAC group whose local buffer for a particular OFM bank exceeds 50% occupancy is temporarily given elevated priority. This mechanism ensures that groups at risk of stalling due to full buffers are serviced first. By decoupling the compute pipeline from the OFM write-back path, this buffer architecture effectively hides write latency, prevents backpressure, and sustains high throughput—even under worst-case OFM bank contention.

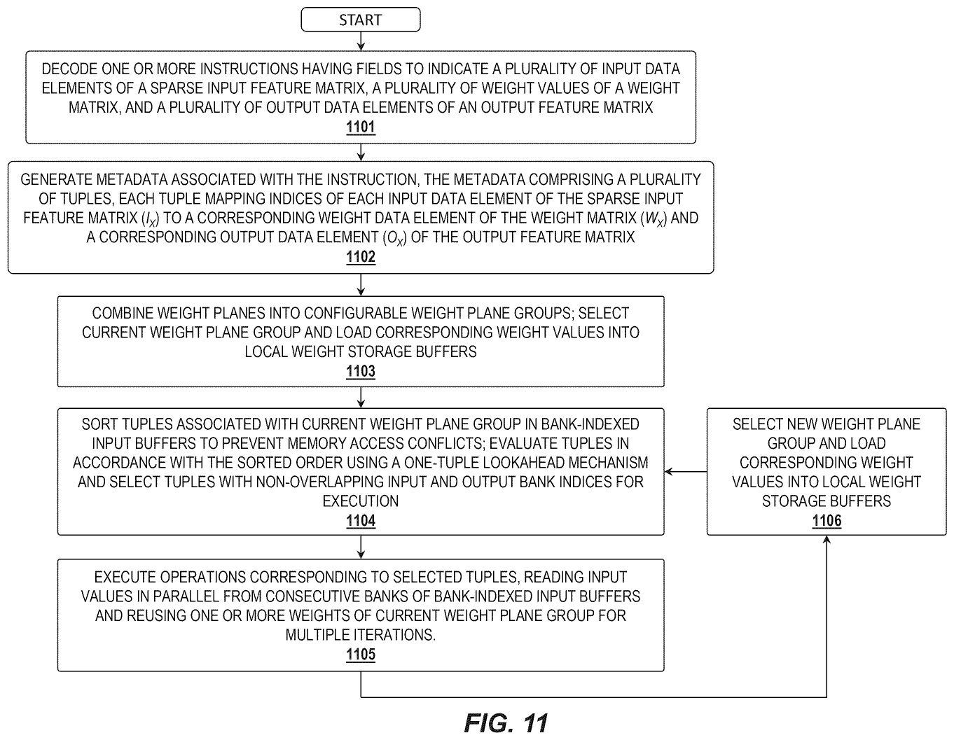

FIG. 11 illustrates a method in accordance with some implementations of this disclosure. At 1101, one or more instructions are decoded, the instructions having fields to indicate a plurality of input data elements of a sparse input feature matrix, a plurality of weight values of a weight matrix, and a plurality of output data elements of an output feature matrix.

At 1102, metadata associated with the instruction is generated. For example, the metadata may comprise a plurality of tuples, each tuple mapping indices of each input data element of the sparse input feature matrix (Iₓ) to a corresponding weight data element of the weight matrix (Wₓ) and a corresponding output data element (Oₓ) of the output feature matrix

At 1103, weight planes are defined and combined to form configurable weight plane groups. A current weight plane group may be dynamically selected in accordance with a defined policy (e.g., the weight plane group with the highest occupancy) and corresponding weight values are loaded into local weight storage buffers.

At 1104, tuples associated with the current weight plane group are sorted in bank-indexed input buffers to prevent memory access conflicts. As previously described, the tuples may be sorted into input bank-indexed FIFO buffers based on the input data memory banking policy. The scheduler then evaluates the tuples in accordance with the sorted order using a one-tuple lookahead mechanism and selects tuples with non-overlapping input and output bank indices for execution.

At 1105, operations corresponding to the selected tuples are executed, reading input values in parallel from consecutive banks of bank-indexed input buffers and reusing one or more weights of current weight plane group for multiple iterations.

When the operations associated with the current weight plane group are complete, a new weight plane group is selected at 1106 and corresponding weight values are loaded into local weight storage buffers. The process then repeats from 1104—sorting tuples associated with the new weight plane group, evaluating the tuples in accordance with the sorted order using a one-tuple lookahead mechanism, and selecting tuples with non-overlapping input and output bank indices for execution.

Compared to existing spatially sparse convolution accelerators, the implementations described herein achieve significantly higher compute and memory bandwidth utilization, as well as consistent performance improvements that scale with increasing sparsity. Moreover, compute utilization realized by these embodiments remains well over 90% for all sparsity levels, with over 90% input cache bandwidth utilization and over 85% output cache bandwidth utilization. Notably, these advancements are achieved with a lightweight, scalable microarchitecture that substantially reduces arbitration overhead and complexity for each data fetch. As a result, these embodiments streamline the management of highly irregular and dynamic on-chip data movement in visual analytics workloads.

Some embodiments of this disclosure include a fine-grained, weight-group aware metadata parser designed to maximize throughput and compute utilization in hardware architectures processing sparse data. These embodiments overcome bottlenecks coarser-grained parsers by enabling parallel, conflict-free tuple decoding and storage, matched to backend consumption rates. Features of these embodiments include, but are not limited to:
Fine-grained pipelining: Enables concurrent decoding and compute operations to minimize stalls.
Weight-group aware rulebook preprocessing: dynamically generates explicit data pointers for each weight group to match backend consumption.
Banked cache architecture: Allows parallel access to rulebook headers and data, eliminating serialization bottleneck
Compute Utilization Improvement: Raises utilization from ˜32% (prior art) to over 75% in high-sparsity workloads (e.g., ScanNet layer 2).
Conflict-free Tuple Generation: Allows conflict-free, high-throughput tuple generation which can be written in a streamlined manner to the bank-aware tuple storage.
Throughput Restoration: Enables backend to consume up to 8 tuples per weight group per cycle, eliminating parser bottlenecks.

Modern compute architectures, especially those targeting sparse workloads used for neural network inference, require the ability to process large volumes of metadata at high throughput. Traditional metadata parsers suffer from coarse-grained pipelining and limited parallelism. In these designs, the frontend parser and backend compute logic operate in a serialized fashion, with frequent stalls as each wait for the other to complete large batches of work. This results in significant idle periods for compute resources, underutilization of hardware, and overall reduced system performance. Furthermore, the throughput of these parsers is fundamentally limited, often producing only a fraction of the tuples per cycle that the backend can consume, making the parser a critical bottleneck.

Some embodiments of the invention include a fine-grained pipelining mechanism between the frontend metadata parser and the backend compute engine. Unlike previous designs that process large batches in a serialized manner, these implementations initiate scheduling as soon as any weight plane reaches a minimum tuple threshold. The active weight plane remains selected until all of its tuples are processed, and the system dynamically transitions to the next weight plane with the highest occupancy. This enables decoding and compute operations to proceed concurrently, significantly reducing idle periods and improving overall resource utilization.

To align the parser's output with the backend's consumption pattern, these embodiments incorporate weight-group aware rulebook preprocessing. The default rulebook format does not natively support weight-group policies, which are essential for efficient parallel processing. The parser in these implementations addresses this limitation by partitioning the rulebook header bitmask into chunks, each corresponding to a specific weight group. For each group, a unique data pointer is computed by summing the bitmask chunks of preceding groups and adding them to the original pointer. This preprocessing step is performed on-the-fly and can be parallelized across multiple header lines, ensuring the parser can generate weight-group-specific pointers at the required rate.

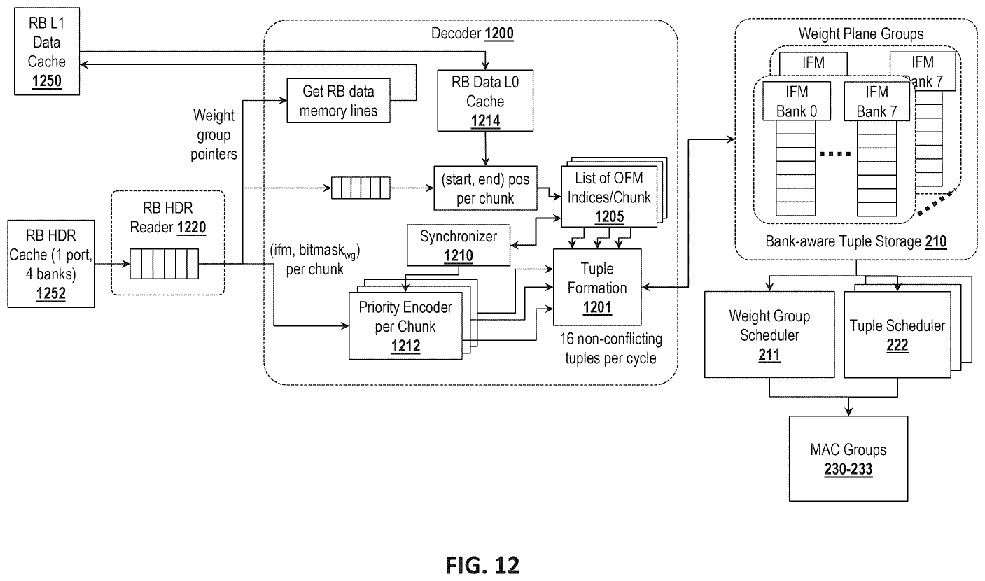

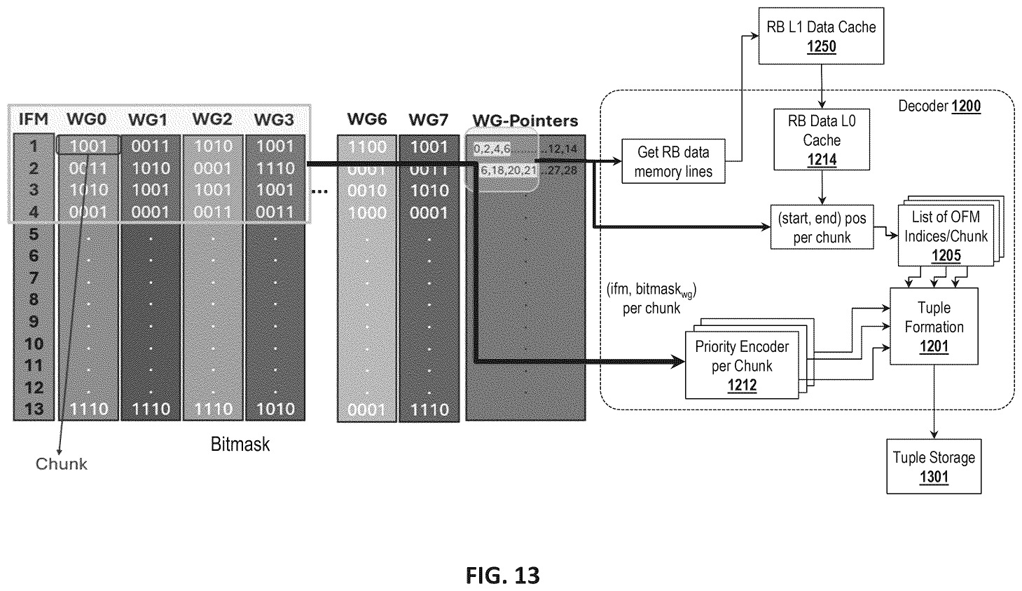

Example implementations of a fine-grained, weight-group aware metadata parsing architecture are illustrated in FIGS. 12-13, which shows a rulebook (RB) L1 data cache 1250 and a RB header (HDR) cache 1252 coupled to a decoder 1200 which includes tuple formation logic 1201 for generating conflict-free tuples as described herein, and synchronizer 1210 for synchronizing the various decoding operations. To support high-throughput, parallel metadata parsing, both the rulebook header cache 1252 and data cache 1250 are banked structures. The header cache 1252 is divided into multiple banks, each storing a subset of rulebook header lines distributed by input bank index. The data cache 1250 is similarly banked, aligned with the header cache to allow simultaneous access to consecutive data lines. This banked organization eliminates the bottlenecks of monolithic cache designs, enabling the parser to read and process multiple header and data entries in parallel, and thus sustaining the high tuple throughput demanded by the backend.

A rulebook header reader provides weight group pointers to the decoder 1200 which responsively loads the corresponding data memory lines into the rulebook data L0 cache 1214 of the decoder 1200 from which lists of output indices per chunk 1205 can be determine. The RB header reader also provides an indication of bitmask chunks to a per-chunk priority encoder 1212 which associates a priority with each chunk. Using the information from the priority encoder 1212 and list of output indices/chunk, the tuple formation logic 1201 generates sets of tuples as descried herein.

FIG. 13 illustrates additional details associated with a plurality of weight groups (WG0-WG7) and corresponding weight group pointers. Each chunk of each weight group is associated with a specified input feature matrix (IFM) index value of a plurality of IFM values shown in the left column. The decoder 1200 uses the weight group pointers to load the corresponding RB data memory lines to the L1 data cache 1250 while groups of chunks are provided to the per-chunk priority encoder 1212.

The effectiveness of these innovations is demonstrated in challenging workloads such as ScanNet layer 2, which features approximately 80% sparsity. With a coarse-grained parser, the overall system could achieve 32% compute utilization, requiring 635 cycles for processing. Transitioning to a fine-grained pipeline improved utilization to 37%, but throughput remained limited. With the new weight-group aware parser and banked cache architecture, utilization exceeds 75%, and processing is completed in just 272 cycles, matching the ideal backend performance and eliminating parser-induced bottlenecks.

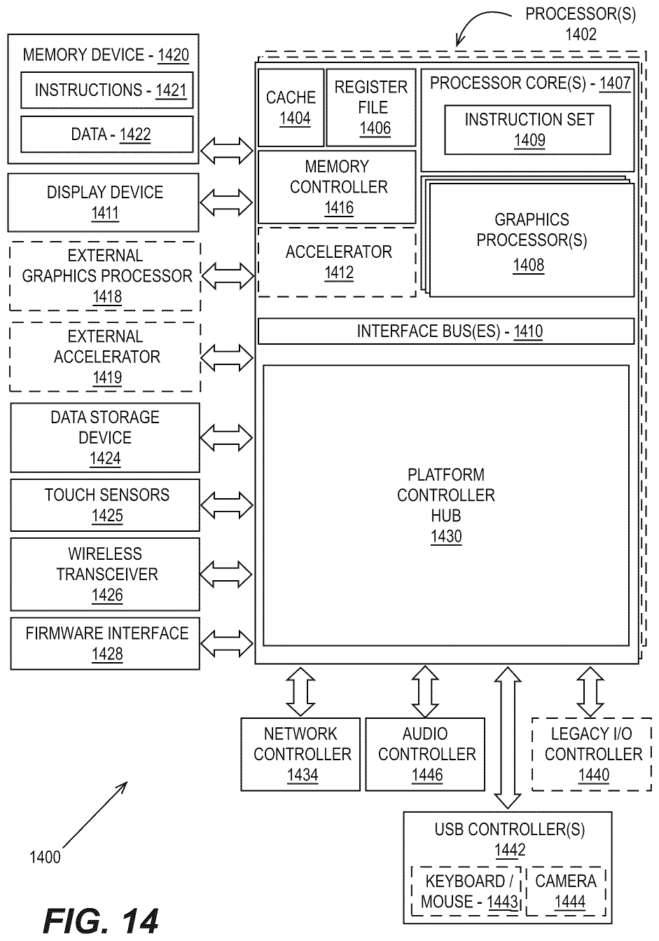

FIG. 14 is a block diagram of a processing system 1400 on which embodiments described herein may be implemented. Processing system 1400 may be used in a single processor desktop system, a multiprocessor workstation system, or a server system having a large number of processors 1402 or processor cores 1407. In one embodiment, the processing system 1400 is a processing platform incorporated within a system-on-a-chip (SoC) integrated circuit for use in mobile, handheld, or embedded devices such as within Internet-of-things (IoT) devices with wired or wireless connectivity to a local or wide area network.

In some embodiments, the one or more processors 1402 each include one or more processor cores 1407 to process instructions which, when executed, perform operations for system or user software. In some embodiments, at least one of the one or more processor cores 1407 is configured to process a specific instruction set which may facilitate Complex Instruction Set Computing (CISC), Reduced Instruction Set Computing (RISC), or computing via a Very Long Instruction Word (VLIW) instruction formats.

One or more processor cores 1407 may process a different instruction set 1409, which may include instructions to facilitate the emulation of other instruction sets. Processor core 1407 may also include other processing devices, such as a Digital Signal Processor (DSP).

In some embodiments, an accelerator 1412 integrated on-chip or on-package with the processors 1402 is a data-access-aware spatially sparse accelerator which avoids memory bank conflicts as described herein. In some embodiments, the accelerator 1412 is a tensor or matrix multiplication accelerator used to accelerate machine learning or compute operations. In one embodiment, an external accelerator 1419 (e.g., coupled to processors 1402 via a high speed interconnect such as PCIe) may be used in place of or in concert with the accelerator 1412.

In some embodiments, the processor 1402 includes cache memory 1404. Depending on the architecture, the processor 1402 can have a single internal cache or multiple levels of internal cache. In some embodiments, the cache memory is shared among various components of the processor 1402. In some embodiments, the processor 1402 also uses an external cache (e.g., a Level-3 (L3) cache or Last Level Cache (LLC)) (not shown), which may be shared among processor cores 1407 using known cache coherency techniques. A register file 1406 can be additionally included in processor 1402 and may include different types of registers for storing different types of data (e.g., integer registers, floating point registers, status registers, and an instruction pointer register). Some registers may be general-purpose registers, while other registers may be specific to the design of the processor 1402.

In some embodiments, one or more processor(s) 1402 are coupled with one or more interface bus(es) 1410 to transmit communication signals such as address, data, or control signals between processor 1402 and other components in the processing system 1400. The interface bus 1410, in one embodiment, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In one embodiment the processor(s) 1402 include a memory controller 1416 and a platform controller hub 1430. The memory controller 1416 facilitates communication between a memory device and other components of the processing system 1400, while the platform controller hub (PCH) 1430 provides connections to I/O devices via a local I/O bus.

The memory device 1420 can be a dynamic random-access memory (DRAM) device, a static random-access memory (SRAM) device, flash memory device, phase-change memory device, or some other memory device having suitable performance to serve as process memory. In one embodiment the memory device 1420 can operate as system memory for the processing system 1400, to store data 1422 and instructions 1421 for use when the one or more processors 1402 executes an application or process. The memory controller 1416 also couples with an optional external graphics processor 1418, which may communicate with the one or more graphics processors 1408 in processors 1402 to perform graphics and media operations.

In some embodiments a display device 1411 can connect to the processor(s) 1402. The display device 1411 can be one or more of an internal display device, as in a mobile electronic device or a laptop device or an external display device attached via a display interface (e.g., DisplayPort, etc.). In one embodiment the display device 1411 can be a head mounted display (HMD) such as a stereoscopic display device for use in virtual reality (VR) applications or augmented reality (AR) applications.

In some embodiments the platform controller hub 1430 enables peripherals to connect to memory device 1420 and processor 1402 via a high-speed I/O bus. The I/O peripherals include, but are not limited to, an audio controller 1446, a network controller 1434, a firmware interface 1428, a wireless transceiver 1426, touch sensors 1425, a data storage device 1424 (e.g., non-volatile memory, volatile memory, hard disk drive, flash memory, NAND, 3D NAND, 3D XPoint, etc.). The data storage device 1424 can connect via a storage interface (e.g., SATA) or via a peripheral bus, such as a Peripheral Component Interconnect bus (e.g., PCI, PCI express). The touch sensors 1425 can include touch screen sensors, pressure sensors, or fingerprint sensors. The wireless transceiver 1426 can be a Wi-Fi transceiver, a Bluetooth transceiver, or a mobile network transceiver such as a 3G, 4G, 5G, or Long-Term Evolution (LTE) transceiver. The firmware interface 1428 enables communication with system firmware, and can be, for example, a unified extensible firmware interface (UEFI). The network controller 1434 can enable a network connection to a wired network. In some embodiments, a high-performance network controller (not shown) couples with the interface bus 1410. The audio controller 1446, in one embodiment, is a multi-channel high-definition audio controller. In one embodiment the processing system 1400 includes an optional legacy I/O controller 1440 for coupling legacy (e.g., Personal System 2 (PS/2)) devices to the system. The platform controller hub 1430 can also connect to one or more Universal Serial Bus (USB) controllers 1442 to connect to input devices, such as keyboard and mouse 1443 combinations, a camera 1444, or other USB input devices.

It will be appreciated that the processing system 1400 shown is exemplary and not limiting, as other types of data processing systems that are differently configured may also be used. For example, an instance of the memory controller 1416 and platform controller hub 1430 may be integrated into a discrete external graphics processor, such as the external graphics processor 1418. In one embodiment the platform controller hub 1430 and/or memory controller 1416 may be external to the one or more processor(s) 1402 and reside in a system chipset that is in communication with the processor(s) 1402.

For example, circuit boards (“sleds”) can be used on which components such as CPUs, memory, and other components are placed, and are designed for increased thermal performance. In some examples, processing components such as the processors are located on a top side of a sled while near memory, such as DIMMs, are located on a bottom side of the sled. As a result of the enhanced airflow provided by this design, the components may operate at higher frequencies and power levels than in typical systems, thereby increasing performance. Furthermore, the sleds are configured to blindly mate with power and data communication cables in a rack, thereby enhancing their ability to be quickly removed, upgraded, reinstalled, and/or replaced. Similarly, individual components located on the sleds, such as processors, accelerators, memory, and data storage drives, are configured to be easily upgraded due to their increased spacing from each other. In the illustrative embodiment, the components additionally include hardware attestation features to prove their authenticity.

A data center can utilize a single network architecture (“fabric”) that supports multiple other network architectures including Ethernet and Omni-Path. The sleds can be coupled to switches via optical fibers, which provide higher bandwidth and lower latency than typical twisted pair cabling (e.g., Category 5, Category 5e, Category 6, etc.). Due to the high bandwidth, low latency interconnections and network architecture, the data center may, in use, pool resources, such as memory, accelerators (e.g., GPUs, graphics accelerators, FPGAs, ASICs, neural network and/or artificial intelligence accelerators, etc.), and data storage drives that are physically disaggregated, and provide them to compute resources (e.g., processors) on an as needed basis, enabling the compute resources to access the pooled resources as if they were local.

A power supply or source can provide voltage and/or current to processing system 1200 or any component or system described herein. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

### EXAMPLE

The following are example implementations of different embodiments of the invention.

Example 1. An apparatus, comprising: front end circuitry to sort a plurality of tuples across a plurality of tuple buffers to provide conflict-free access to a corresponding plurality of input data banks storing a plurality of input data elements of a sparse input tensor, each tuple to associate an input data element of the plurality of input data elements with a corresponding weight data element of a weight tensor and a corresponding output data element of an output tensor; and execution circuitry to perform multiply-accumulate operations using a subset of tuples of the plurality of tuples, the execution circuitry to perform parallel multiplications with a corresponding subset of input data elements of the plurality of input data elements and a corresponding subset of weight data elements of the weight tensor indicated by the subset of the tuples, the execution circuitry to access to the subset of input data elements from different input data banks of the plurality of input data banks without memory access conflicts.

Example 2. The apparatus of example 1, wherein each tuple buffer is to store tuples associated with input data elements having input bank indices indicating a corresponding input data bank of the plurality of input data banks, wherein the front end circuitry further comprises a scheduler to select the subset of tuples to be concurrently executed by the execution circuitry.

Example 3. The apparatus of example 1 or 2, further comprising: a plurality of output data banks to store output data elements generated by the multiply-accumulate operations, wherein the scheduler is to determine the subset of tuples to be concurrently executed based on the subset of tuples having non-overlapping input bank indices to access the input data banks and non-overlapping output bank indices to access the output data banks.

Example 4. The apparatus of any of examples 1-2, wherein the front end circuitry further comprises: a weight group scheduler to dispatch weight data elements of the weight tensor to the execution circuitry in weight groups, the weight data elements of each weight group selected in accordance with a weight group stationary execution model.

Example 5. The apparatus of any of examples 1-4, wherein the weight data elements of each weight group are dispatched and stored in registers or local buffers of the execution circuitry across multiple multiply-accumulation operation cycles.

Example 6. The apparatus of any of examples 1-5, wherein the subset of weight data elements used for the parallel multiplications comprise weight data elements of a first weight group, the subset of weight data elements to be reused for subsequent parallel multiplications with a different subset of input data elements.

Example 7. The apparatus of any of examples 1-6, wherein the execution circuitry comprises a plurality of multiply-accumulate (MAC) circuits arranged in conflict-free MAC groups, wherein the subset of tuples comprises a first subset of tuples to be executed by a first conflict-free MAC group, the scheduler to determine a plurality of additional subsets of tuples to be executed by a corresponding plurality of additional MAC groups, each subset of tuples selected to provide for conflict-free access to the input data banks and the output data banks.

Example 8. The apparatus of any of examples 1-7, wherein the sparse input tensor comprises a sparse input matrix and the weight tensor comprises a weight matrix.

Example 9. A method, comprising: storing a plurality of input data elements of a sparse input tensor in a plurality of input data banks; storing a plurality of tuples in a plurality of tuple buffers, each tuple to associate an input data element of the plurality of input data elements with a corresponding weight data element of a weight tensor and a corresponding output data element of an output tensor, wherein each tuple buffer is to store tuples indicating input data elements having input bank indices of a corresponding input data bank of the plurality of input data banks; sorting the plurality of tuples across the plurality of tuple buffers based on the corresponding input bank indices to provide for conflict-free access to the plurality of input data elements from the plurality of input data banks; and scheduling a subset of tuples of the plurality of tuples for concurrent execution; and performing, by execution circuitry, multiply-accumulate operations based on the subset of tuples, including performing parallel multiplications with a corresponding subset of input data elements of the plurality of input data elements and a corresponding subset of weight data elements of the weight tensor indicated by the subset of the tuples, the subset of input data elements to be accessed from different input data banks of the plurality of input data banks.

Example 10. The method of example 9, further comprising: storing output data elements generated by the multiply-accumulate operations in a plurality of output data banks, wherein the subset of tuples to be concurrently executed are determined based on the subset of tuples having non-overlapping input bank indices to access the input data banks and non-overlapping output bank indices to access the output data banks.

Example 11. The method of examples 9 or 10, further comprising: dispatching, by a weight group scheduler, weight data elements of the weight tensor to the execution circuitry in weight groups, the weight data elements of each weight group selected in accordance with a weight group stationary execution model.

Example 12. The method of any of examples 9-11, wherein the weight data elements of each weight group are dispatched and stored in registers or local buffers of the execution circuitry across multiple multiply-accumulation operation cycles.

Example 13. The method of any of examples 9-12, wherein the subset of weight data elements used for the parallel multiplications comprise weight data elements of a first weight group, the subset of weight data elements to be reused for subsequent parallel multiplications with a different subset of input data elements.

Example 14. The method of any of examples 9-13, wherein the execution circuitry comprises a plurality of multiply-accumulate (MAC) circuits arranged in conflict-free MAC groups, wherein the subset of tuples comprises a first subset of tuples to be executed by a first conflict-free MAC group, the scheduler to determine a plurality of additional subsets of tuples to be executed by a corresponding plurality of additional MAC groups, each subset of tuples selected to provide for conflict-free access to the input data banks and the output data banks.

Example 15. The method of any of examples 9-14, wherein the sparse input tensor comprises a sparse input matrix and the weight tensor comprises a weight matrix.

Example 16. A machine-readable medium having program code stored thereon which, when executed by a machine, causes the machine to perform operations comprising: storing a plurality of input data elements of a sparse input tensor in a plurality of input data banks; storing a plurality of tuples in a plurality of tuple buffers, each tuple to associate an input data element of the plurality of input data elements with a corresponding weight data element of a weight tensor and a corresponding output data element of an output tensor, wherein each tuple buffer is to store tuples indicating input data elements having input bank indices of a corresponding input data bank of the plurality of input data banks; sorting the plurality of tuples across the plurality of tuple buffers based on the corresponding input bank indices to provide for conflict-free access to the plurality of input data elements from the plurality of input data banks; and scheduling a subset of tuples of the plurality of tuples for concurrent execution; and performing, by execution circuitry, multiply-accumulate operations based on the subset of tuples, including performing parallel multiplications with a corresponding subset of input data elements of the plurality of input data elements and a corresponding subset of weight data elements of the weight tensor indicated by the subset of the tuples, the subset of input data elements to be accessed from different input data banks of the plurality of input data banks.

Example 17. The machine-readable medium of example 16, further comprising program code to cause the machine to perform the operations of: storing output data elements generated by the multiply-accumulate operations in a plurality of output data banks, wherein the subset of tuples to be concurrently executed are determined based on the subset of tuples having non-overlapping input bank indices to access the input data banks and non-overlapping output bank indices to access the output data banks.

Example 18. The machine-readable medium of examples 16 or 17, further comprising program code to cause the machine to perform the operations of: dispatching, by a weight group scheduler, weight data elements of the weight tensor to the execution circuitry in weight groups, the weight data elements of each weight group selected in accordance with a weight group stationary execution model.

Example 19. The machine-readable medium of any of examples 16-18, wherein the weight data elements of each weight group are dispatched and stored in registers or local buffers of the execution circuitry across multiple multiply-accumulation operation cycles.

Example 20. The machine-readable medium of any of examples 16-19, wherein the subset of weight data elements used for the parallel multiplications comprise weight data elements of a first weight group, the subset of weight data elements to be reused for subsequent parallel multiplications with a different subset of input data elements.

Example 21. The machine-readable medium of any of examples 16-20, wherein the execution circuitry comprises a plurality of multiply-accumulate (MAC) circuits arranged in conflict-free MAC groups, wherein the subset of tuples comprises a first subset of tuples to be executed by a first conflict-free MAC group, the scheduler to determine a plurality of additional subsets of tuples to be executed by a corresponding plurality of additional MAC groups, each subset of tuples selected to provide for conflict-free access to the input data banks and the output data banks.

Example 22. The machine-readable medium of any of examples 16-21, wherein the sparse input tensor comprises a sparse input matrix and the weight tensor comprises a weight matrix.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. An apparatus, comprising:
front end circuitry to sort a plurality of tuples across a plurality of tuple buffers to provide conflict-free access to a corresponding plurality of input data banks storing a plurality of input data elements of a sparse input tensor without memory access conflicts, each tuple to associate an input data element of the plurality of input data elements with a corresponding weight data element of a weight tensor and a corresponding output data element of an output tensor; and
execution circuitry to perform multiply-accumulate operations using a subset of tuples of the plurality of tuples, the execution circuitry to perform parallel multiplications with a corresponding subset of input data elements of the plurality of input data elements and a corresponding subset of weight data elements of the weight tensor indicated by the subset of the tuples, the execution circuitry to access the subset of input data elements from different input data banks of the plurality of input data banks without memory access conflicts.

2. The apparatus of claim 1, wherein each tuple buffer is to store tuples associated with input data elements having weight group indices indicating a corresponding weight group and input bank indices indicating a corresponding input data bank of the plurality of input data banks, wherein the front end circuitry further comprises a scheduler to select the subset of tuples to be concurrently executed by the execution circuitry.

3. The apparatus of claim 2, further comprising:
a plurality of output data banks to store output data elements generated by the multiply-accumulate operations, wherein the scheduler is to determine the subset of tuples to be concurrently executed based on the subset of tuples having non-overlapping input bank indices to access the input data banks and non-overlapping output bank indices to access the output data banks.

4. The apparatus of claim 3, wherein the front end circuitry is to perform a one-tuple lookahead for each tuple buffer to select tuples with non-overlapping input and output bank indices for execution.

5. The apparatus of claim 2, wherein the front end circuitry further comprises:
a weight group scheduler to dispatch weight data elements of the weight tensor to the execution circuitry in weight groups, the weight data elements of each weight group selected in accordance with a weight group stationary execution model.

6. The apparatus of claim 5, wherein the weight data elements of each weight group are dispatched and stored in registers or local buffers of the execution circuitry across multiple multiply-accumulation operation cycles.

7. The apparatus of claim 6, wherein the subset of weight data elements used for the parallel multiplications comprise weight data elements of a first weight group, the subset of weight data elements to be reused for subsequent parallel multiplications with a different subset of input data elements.

8. The apparatus of claim 3, wherein the execution circuitry comprises a plurality of multiply-accumulate (MAC) circuits arranged in one or more conflict-free MAC groups, wherein the subset of tuples comprises a first subset of tuples to be executed by a first conflict-free MAC group, the scheduler to determine a plurality of additional subsets of tuples to be executed by a corresponding plurality of additional MAC groups, each subset of tuples selected to provide for conflict-free access to the input data banks and the output data banks.

9. The apparatus of claim 1, wherein the sparse input tensor comprises a sparse input matrix and the weight tensor comprises a weight matrix.

10. A method, comprising:
storing a plurality of input data elements of a sparse input tensor in a plurality of input data banks;
storing a plurality of tuples in a plurality of tuple buffers, each tuple to associate an input data element of the plurality of input data elements with a corresponding weight data element of a weight tensor and a corresponding output data element of an output tensor, wherein each tuple buffer is to store tuples indicating input data elements having input bank indices of a corresponding input data bank of the plurality of input data banks and weight group indices of a corresponding weight group;
sorting the plurality of tuples across the plurality of tuple buffers based on the corresponding input bank indices to provide for conflict-free access to the plurality of input data elements from the plurality of input data banks without memory access conflicts;
scheduling a subset of tuples of the plurality of tuples for concurrent execution; and
performing, by execution circuitry, multiply-accumulate operations based on the subset of tuples, including performing parallel multiplications with a corresponding subset of input data elements of the plurality of input data elements and a corresponding subset of weight data elements of the weight tensor indicated by the subset of the tuples, the subset of input data elements to be accessed from different input data banks of the plurality of input data banks.

11. The method of claim 10, further comprising:
storing output data elements generated by the multiply-accumulate operations in a plurality of output data banks, wherein the subset of tuples to be concurrently executed are determined based on the subset of tuples having non-overlapping input bank indices to access the input data banks and non-overlapping output bank indices to access the output data banks.

12. The method of claim 10, further comprising:
dispatching, by a weight group scheduler, weight data elements of the weight tensor to the execution circuitry in weight groups, the weight data elements of each weight group selected in accordance with a weight group stationary execution model.

13. The method of claim 12, wherein the weight data elements of each weight group are dispatched and stored in registers or local buffers of the execution circuitry across multiple multiply-accumulation operation cycles.

14. The method of claim 13, wherein the subset of weight data elements used for the parallel multiplications comprise weight data elements of a first weight group, the subset of weight data elements to be reused for subsequent parallel multiplications with a different subset of input data elements.

15. The method of claim 11, wherein the execution circuitry comprises a plurality of multiply-accumulate (MAC) circuits arranged in one or more conflict-free MAC groups, wherein the subset of tuples comprises a first subset of tuples to be executed by a first conflict-free MAC group, the scheduler to determine a plurality of additional subsets of tuples to be executed by a corresponding plurality of additional MAC groups, each subset of tuples selected to provide for conflict-free access to the input data banks and the output data banks.

16. The method of claim 10, wherein the sparse input tensor comprises a sparse input matrix and the weight tensor comprises a weight matrix.

17. A machine-readable medium having program code stored thereon which, when executed by a machine, causes the machine to perform operations comprising:
storing a plurality of input data elements of a sparse input tensor in a plurality of input data banks;
storing a plurality of tuples in a plurality of tuple buffers, each tuple to associate an input data element of the plurality of input data elements with a corresponding weight data element of a weight tensor and a corresponding output data element of an output tensor, wherein each tuple buffer is to store tuples indicating input data elements having input bank indices of a corresponding input data bank of the plurality of input data banks and weight group indices of a corresponding weight group;
sorting the plurality of tuples across the plurality of tuple buffers based on the corresponding input bank indices to provide for conflict-free access to the plurality of input data elements from the plurality of input data banks without memory access conflicts;
scheduling a subset of tuples of the plurality of tuples for concurrent execution; and
performing, by execution circuitry, multiply-accumulate operations based on the subset of tuples, including performing parallel multiplications with a corresponding subset of input data elements of the plurality of input data elements and a corresponding subset of weight data elements of the weight tensor indicated by the subset of the tuples, the subset of input data elements to be accessed from different input data banks of the plurality of input data banks.

18. The machine-readable medium of claim 17, further comprising program code to cause the machine to perform the operations of:
storing output data elements generated by the multiply-accumulate operations in a plurality of output data banks, wherein the subset of tuples to be concurrently executed are determined based on the subset of tuples having non-overlapping input bank indices to access the input data banks and non-overlapping output bank indices to access the output data banks.

19. The machine-readable medium of claim 17, further comprising program code to cause the machine to perform the operations of:
dispatching, by a weight group scheduler, weight data elements of the weight tensor to the execution circuitry in weight groups, the weight data elements of each weight group selected in accordance with a weight group stationary execution model.

20. The machine-readable medium of claim 18, wherein the weight data elements of each weight group are dispatched and stored in registers or local buffers of the execution circuitry across multiple multiply-accumulation operation cycles.
